(19) United States
(12) Patent Application Publication
(10) Pub. No.: US 2025/0262970 A1
(43) Pub. Date: Aug. 21, 2025

(54) ELECTRIC VEHICLE SUPPLY EQUIPMENT MANAGEMENT SYSTEM

(71) Applicant: BorgWarner Inc., Auburn Hills, MI (US)

(72) Inventors: Fabrizio BELLONI, Bagnacavallo (IT); Francesca GUGLIELMO, Imola (IT); Enrico VALENTINI, Imola (IT); Douglas KUNZ, Ravenna (IT); Luca DI CARLO, Teramo (IT)

(21) Appl. No.: 18/702,475

(22) PCT Filed: Oct. 25, 2021
(86) PCT No.: PCT/US2021/056397

§ 371 Date: Apr. 18, 2024

(51) Int. Cl. B60L 53/62; B60L 53/18; B60L 53/66

(52) U.S. Cl. CPC B60L 53/62; B60L 53/18; B60L 53/665

(57) ABSTRACT

A method of managing electric vehicle (EV) supply equipment that includes detecting a plurality of EVs are electrically connected to EV supply equipment via electrical cables that communicate electrical current from a grid to vehicle batteries on the EVs through the EV supply equipment: assigning a queue value to each EV based on the order in which the EV electrically connected to the EV supply equipment: determining that the quantity of EVs electrically connected to the EV supply equipment exceeds a maximum number of EVs the EV supply equipment can charge at once; and selecting the electrically connected EVs to charge via active cables based on queue values while the remaining electrically connected EVs wait for charging via queued cables.

### TECHNICAL FIELD

The present application relates to electric vehicles (EVs) and, more particularly, to EV supply equipment that connects to an electric grid and charges the EVs.

### BACKGROUND

In the past, the number of electric vehicles (EVs) in use on public roads has been small. Traditionally, the vast number of vehicles have been fueled with petroleum-based fuels, the functionality of which have been supported by a vast network of fueling stations. However, the number of EVs sold has steadily increased creating the need for a network of charging stations that charge vehicle batteries carried by the EVs. Unlike the petroleum-based fueling infrastructure that fuel internal combustion engine (ICE) vehicles relatively quickly, the vehicle battery charging stations—also referred to as EV supply equipment-function in a much different way, which presents a number of challenges to overcome so that EVs can be charged or “fueled” in a way that is convenient for drivers.

### SUMMARY

In one implementation, a method of managing electric vehicle (EV) supply equipment that includes detecting a plurality of EVs are electrically connected to EV supply equipment via electrical cables that communicate electrical current from a grid to vehicle batteries on the EVs through the EV supply equipment; assigning a queue value to each EV based on the order in which the EV electrically connected to the EV supply equipment; determining that the quantity of EVs electrically connected to the EV supply equipment exceeds a maximum number of EVs the EV supply equipment can charge at once; and selecting the electrically connected EVs to charge via active cables based on queue values while the remaining electrically connected EVs wait for charging via queued cables.

In another implementation, EV supply equipment is configured to electrically connect with a plurality of EVs, and included one or more active cables configured to electrically connect with EVs; and one or more queue cables configured to electrically connect with EVs; wherein the EV supply equipment detects a plurality of EVs are electrically connected to EV supply equipment via the active cable(s) and the queue cable(s) that communicate electrical current from a grid to vehicle batteries on the EVs, assign a queue value to each EV based on the order in which the EV electrically connected to the EV supply equipment, determines that the quantity of EVs electrically connected to the EV supply equipment exceeds a maximum number of EVs the EV supply equipment can charge at once, and selects a quantity of electrically connected EVs to charge via active cables while the remaining electrically connected EVs wait for charging via queued cables.

### BRIEF DESCRIPTION OF THE DRAWINGS

FIG. 1 is a block diagram depicting an implementation of electric vehicle (EV) supply equipment and an EV;

FIG. 2 is a block diagram depicting an implementation of an EV supply equipment management system; and

FIG. 3 is a flow chart depicting an implementation of a method of managing EV supply equipment.

### DETAILED DESCRIPTION

A system and method of charging electric vehicles (EVs) is shown. The system includes EV supply equipment—sometimes referred to as an EV battery charger—that is capable of charging more than one EV at once. In some environments, the EV supply equipment may include a plurality of charging cables each able to electrically connect to an EV and charge an on-board vehicle battery with electrical power supplied by a fixed source, such as an electrical grid. In the past, the EV supply equipment has included a quantity of electrical cables that matched the quantity of EVs that the EV supply equipment could service at one time. When the number of EVs connected to the EV supply equipment matched the number of electrical cables, drivers who sought to electrically connect an additional EV to the EV supply equipment would then wait until the operator of a currently-connected EV disconnected from one of the electrical cables thereby providing capacity for a different EV to be electrically connected to the EV supply equipment. However, under such circumstances, operators of the EVs not electrically connected to the EV supply equipment would wait with their vehicles until an operator of an EV currently being charges was disconnected to free one of the electrical cables. That is, a vehicle operator had to wait with the EV for an electrical cable became free. This limited a vehicle operator who wanted to charge their EV from leaving their EV until a currently charging EV has been disconnected and the operator typically does not have information indicating when an electrical cable will become free.

The proposed system of EV supply equipment includes a greater quantity of electrical cables than EVs that the equipment can charge at once. The EV supply equipment manages a queue for providing electrical charge permitting an EV vehicle operator to electrically connect an EV even though the EV supply equipment may not be able to provide electrical charge at the time the EV is electrically connected to the EV supply equipment. The EV supply equipment can determine how many EVs are currently electrically connected to the equipment, what time each EV was electrically connected, the current charge state of each EV, and, when an earlier connected EV has reached a desired electrical charge state, the EV supply equipment can stop or reduce charging an earlier-connected EV and begin charging a later-connected EV. In this system, later-arriving EV operators can electrically connect an EV to the EV supply equipment even though the EV supply equipment is not able to provide electrical charge and, once the EV supply equipment is able, the equipment can automatically begin charging when able without operator input.

Turning to FIG. 1, an implementation of an electrical grid 12, an EV 14 that can receive electrical power from the grid 12, and EV supply equipment 16 is shown. The electrical grid 12 can include any one of a number of electrical power generators and electrical delivery mechanisms. Electrical generators (not shown), such as nuclear-, hydraulic-, or wind-powered plants that convert the energy of nuclear fission, flow of water through dams, or wind power of a turbine, create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power received by the residence or business is 240 volts (V). However, this voltage can be a different value.

EV supply equipment 16, also referred to as an electric vehicle-charging station or an EV battery charger, can receive the AC electrical power from the grid 12 and provide the electrical power to the EV 14. The charging station 16 can be geographically fixed, such as a charging station located in a vehicle garage or in a vehicle parking lot. The charging station 16 can include an input terminal that receives the AC electrical power from the grid 12 and communicates the AC electrical power to an on-board vehicle battery charger 18 included on the EV 14. An electrical cable 20 can detachably connect with an electrical receptacle on the EV 14 and electrically link the charging station 16 with the EV 14 so that AC electrical power can be communicated between the charging station 16 and the EV 14. The charging station 16 can be classified by what is commonly referred to as “Mode 3” EV supply equipment that receives 240 VAC from the grid 12 and supplies 240 VAC to the EV 14 as that term has been defined by the International Electrotechnical Commission (IEC) in IEC 61851-1. It is possible the level of AC electrical power input to a charging station and/or the level of AC electrical power output from a charging station is different in other implementations. The EV supply equipment 16 can be controlled using any type of device capable of processing electronic instructions including microprocessors, microcontrollers, host processors, controllers, and application specific integrated circuits (ASICs). It can be a dedicated processor used only to direct the functionality of the EV supply equipment 16 or can be shared with other systems. The controller executes various types of digitally-stored instructions, such as software or firmware programs stored in memory. The EV supply equipment used with the methods disclosed here can be implemented with charging equipment that is not located on the EV such that current conversion from AC to DC occurs at the equipment. In another implementation, the EV supply equipment 16 can be implemented using what is commonly described as “mode 4” equipment. Mode 4 has been defined by the IEC in IEC 61851-1. However, the EV supply equipment should not be viewed as limited by this standard or any other standard considering that the standards evolve and the methods described could be used with other standards.

The term “EV” can refer to vehicles that are propelled, either wholly or partially, by electric motors. EV can refer to electric vehicles, plug-in electric vehicles, hybrid electric vehicles, and battery powered vehicles. The vehicle battery 22 can supply DC electrical power, that has been converted from AC electrical power, to the electric motors that propel the EV. The vehicle battery 22 or batteries are rechargeable and can include lead-acid batteries, nickel cadmium (NiCd), nickel metal hydride, lithium-ion, and lithium polymer batteries. A typical range of vehicle battery voltages can range from 200 to 800V of DC electrical power (VDC).

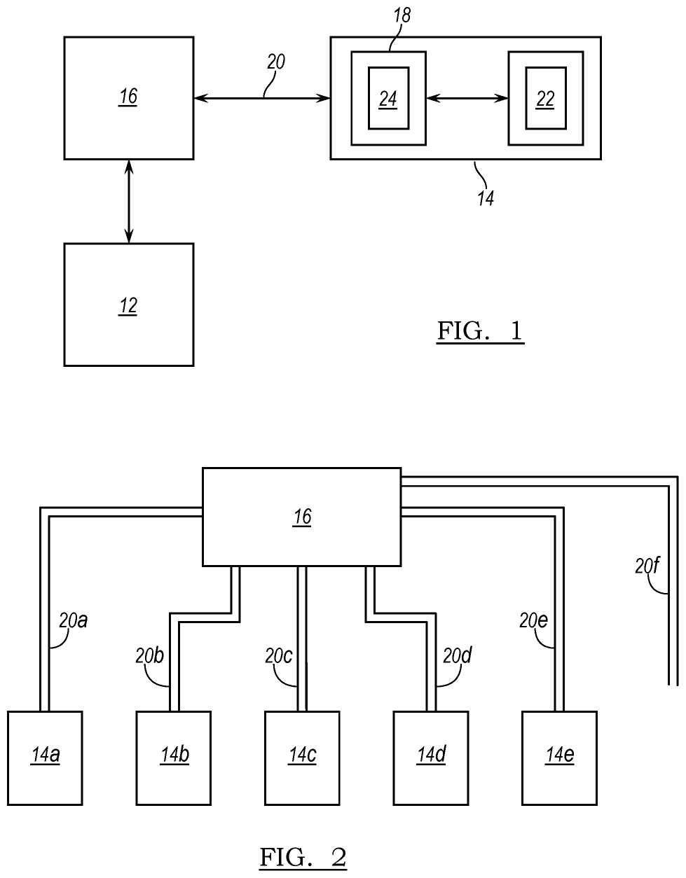

Turning to FIG. 2, an implementation of the EV supply equipment 16 is shown that includes a quantity of electrical cables 20 that is greater than the quantity of EVs that the equipment 16 can fully charge at one time. That is, the EV supply equipment 16 cannot deliver a maximum value of electrical current to all of the electrical cables 20 available to be electrically connected to EVs 14. The implementation shown in FIG. 2 involves EV supply equipment 16 that offers six electrical cables 20a-20f yet is able to provide a maximum amount of charging current to three EVs 14 at one time. In this example, five EVs 14a-14e are connected to electrical cables 20a-20e and each can be assigned a queue value based on the order in which they were electrically connected to the EV supply equipment 16. The first three EVs 14a-14c to be connected to the EV supply equipment 16 can receive the maximum value of electrical current able to be applied to the vehicle battery 22. The next two EVs 14d-14e can be physically connected to the EV supply equipment 14 but not yet receiving electrical current (charge) until the equipment 14 has delivered sufficient charge to the first three EVs 14a-14c.

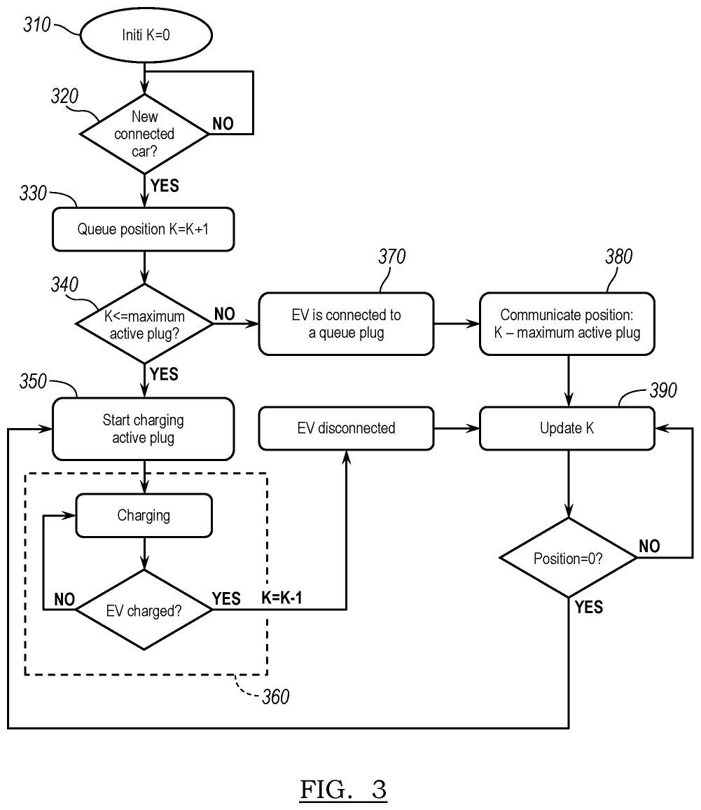

FIG. 3 depicts an implementation of a method 300 of managing EV supply equipment 16. The method 300 begins at step 310 by initiating a queue. The queue can be an ordered number of EVs 14 organized by the order in which each EV 14 electrically connected to the EV supply equipment 16 via an electrical cable 20. The EV supply equipment 16 can initially set a queue value (k) to be zero or the equipment 16 can detect the number of EVs 14 currently connected to the equipment 16 via electrical cables 20 and set the value of k equal to the number of EVs 14 currently connected. The method 300 proceeds to step 320.

At step 320, the EV supply equipment 16 determines if an EV 14 has been connected to the EV supply equipment 16. If so, the value k can be incremented by one. The EV supply equipment 16 can include a microprocessor that can receive a signal when an electrical cable 20 is physically attached to an EV 14. In one implementation, an input of the microprocessor can detect the presence of a voltage when previously, when the electrical cable 20 was unattached, there was an absence of voltage. For example, the voltage can rise from 0 volts (V) to 5V. The processor can access an internal clock and determine the time at which the voltage level changed and the EV 14 became electrically connected to the EV service equipment 16. The method 300 proceeds to step 340.

At step 340, the EV supply equipment 16 determines if the maximum number of EVs 14 the equipment 16 can charge has been exceeded. The maximum number value can be stored at the EV supply equipment 16 in a memory device. For example, the memory internal to the processor can be programmed with this value. The processor can then compare the current value of k is less than, equal to, or greater than the maximum number value. If the value is equal to or less than the maximum number value, the method 300 proceeds to step 350 and the equipment 16 begins charging all of the EVs 14 electrically connected to the equipment 16. Otherwise, the method 300 proceeds to step 370.

At step 350, the EV supply equipment 16 designates a quantity of electrical cables 20 equal to the maximum number of EVs 14 the equipment 16 can charge as “active cables” and provides a maximum amount of electric current to the EVs 14 attached to the active cables. So long as the number of EVs 14 attached to the EV supply equipment 16 is equal to or less than the maximum number of EVs the equipment 16 can charge, the maximum amount of current can be delivered to the active cables at step 350. The method 300 proceeds to step 360.

At step 360, the EV supply equipment 16 charges the EVs 14 electrically connected to the equipment 16 via active cables until each EV reaches a desired level of vehicle battery charge. The desired level could be fully charged or some other level less than fully charged. The EV supply equipment 16 can periodically determine via the electrical cable 20 whether each EV 14 has reached this level. When the EV 14 has reached the desired level of vehicle battery charge, the method 300 proceeds to step 390.

At step 370, the EVs 14 in the queue that were electrically connected to the EV supply equipment 16 after the EVs attached to the active cables, are attached to electrical cables 20 designated as “queued cables.” The queued cables can be physically attached to EVs 14 yet not provide electrical current or provide a reduced amount of electrical current. The EV supply equipment 16 can indicate visually, audibly, or by sending a wirelessly-transmitted message, the position of the EV 14 attached to the queued cable in the queue at step 380. This message can convey how many EVs 14 will receive electrical current before the queued EV 14 or otherwise communicate where in the queue the current EV or each EV is positions.

At step 390, the EV 14 connected to the EV supply equipment 16 via an active cable that has reached a desired level of charge can be disconnected from the equipment. The EV supply equipment 16 can then update the queue to remove the EV 14 that reached the desired level of charge, the remaining EVs 14 connected to active cables and queued cables can be assigned a new position in the queue. If an EV 14 is electrically connected to a queue cable, the EV supply equipment 16 can change the designation of the electrical cable 20 from a queue cable to an active cable and the equipment 16 can begin delivering electrical current to the EV 14 next in the queue via an active cable. The queue is updated to reflect the current order of electrically-attached EVs 14. Alterations to this method flow are possible. For example, the assignment of an active cable or a queued cable to a particular EV based on a queue value can be influenced by the receipt of payment from an EV operator. If an EV operator electrically connects an EV to the EV supply equipment 16 and learns that the position of the EV in the queue will mean that the electrical cable the operator has attached to the EV is a queued cable, the EV supply equipment may offer the operator the opportunity to submit a payment to receive a different position in the queue such that the EV will receive electrical current earlier than the EV would if such a payment was not paid.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of managing electric vehicle (EV) supply equipment, comprising:
(a) detecting a plurality of EVs are electrically connected to EV supply equipment via electrical cables that communicate electrical current from a grid to vehicle batteries on the EVs through the EV supply equipment;
(b) assigning a queue value to each EV based on the order in which the EV electrically connected to the EV supply equipment;
(c) determining that the quantity of EVs electrically connected to the EV supply equipment exceeds a maximum number of EVs the EV supply equipment can charge at once; and
(d) selecting the electrically connected EVs to charge via active cables based on queue values while the remaining electrically connected EVs wait for charging via queued cables.

2. The method recited in claim 1 further comprising the step of determining that an EV has been disconnected from the EV supply equipment and updating the queue value associated with each EV.

3. The method recited in claim 1 further comprising the step of reducing an amount of electrical current delivered to the active cables and also providing electrical current to the queue cables.

4. The method recited in claim 1 further comprising the steps of receiving payment and changing the queue value of an EV in response.

5. Electric vehicle (EV) supply equipment configured to electrically connect with a plurality of EVs, comprising:
one or more active cables configured to electrically connect with EVs; and
one or more queue cables configured to electrically connect with EVs;, wherein the EV supply equipment detects a plurality of EVs are electrically connected to EV supply equipment via the active cable(s) and the queue cable(s) that communicate electrical current from a grid to vehicle batteries on the EVs, assign a queue value to each EV based on the order in which the EV electrically connected to the EV supply equipment, determines that the quantity of EVs electrically connected to the EV supply equipment exceeds a maximum number of EVs the EV supply equipment can charge at once, and selects a quantity of electrically connected EVs to charge via active cables while the remaining electrically connected EVs wait for charging via queued cables.

6. The EV supply equipment recited in claim 5, wherein the EV supply equipment determines that an EV has been disconnected from the EV supply equipment and updates the queue value associated with each EV.

7. The EV supply equipment recited in claim 5, wherein the EV supply equipment reduces an amount of electrical current delivered to the active cables and also provides electrical current to the queue cables.

8. The method recited in claim 5 further comprising the steps of receiving payment and changing the queue value of an EV in response.
